(19) United States
(12) Patent Application Publication
(10) Pub. No.: US 2010/0290660 A1
(43) Pub. Date: Nov. 18, 2010

(54) VIBRATION PICKUP MICROPHONE

(75) Inventor: Mikio Fukuda, Tokyo (JP)

Correspondence Address: SCHMEISER, OLSEN & WATTS, 22 CENTURY HILL DRIVE, SUITE 302, LATHAM, NY, 12110, US

(73) Assignee: TEMCO JAPAN CO., LTD., TOKYO (JP)

(21) Appl. No.: 12/863,454

(22) PCT Filed: Feb. 6, 2009
(86) PCT No.: PCT/JP2009/000455

§ 371 Date: Jul. 19, 2010

(30) Foreign Application Priority Data
Feb. 8, 2008 (JP) 2008-029523

(51) Int. Cl. H04R 1/02

(52) U.S. Cl. 381/355

(57) ABSTRACT

To provide a microphone used for telecommunication or speech recognition input in a high noise environment, or more specifically, a vibration pickup microphone that hardly howls even when transmission and reception occur simultaneously. A vibration pickup microphone has: a housing 1 attached to a human body contact surface of a transmitter/receiver or the like; a microphone unit 2 of an aerial vibration collecting type incorporated in the housing 1; and a microphone holder 5 that is made of an elastic material and supports the microphone unit 2 in the housing 1. The housing 1 has a case 3 having an opening in an upper surface thereof, in which the microphone holder 5 is fitted, and a cover 4 that is made of an elastic material and covers an outer surface of the case 3. A multilayered diaphragm 6 is disposed on an upper surface of the microphone holder 5 with an air space 16 formed between the multilayered diaphragm 6 and the microphone holder 5. A sealed cavity 7 is formed between diaphragms 6a and 6b constituting the multilayered diaphragm 6.

### FIELD OF THE TECHNOLOGY

The present invention relates to a vibration pickup microphone. In particular, it relates to a vibration pickup microphone that picks up a bone vibration or a vocal cord vibration.

### BACKGROUND

Bone conduction microphones and throat microphones are microphones that are less sensitive to external noise and pick up only the voice of a speaker. A representative example of the bone conduction microphone that picks up a bone vibration is an acceleration pickup microphone, which incorporates a piezoelectric element held by a supporting part as shown in FIG. 5.

The microphone of this type has a disadvantage that it is susceptible to a mechanical vibration. More specifically, when something comes into contact with the housing or cable, the microphone significantly picks up the unwanted vibration or friction noise. The microphone of this type further has a disadvantage that a sufficient S/N ratio cannot be ensured in a high noise environment where the sound pressure level (SPL) is higher than 110 dB, because the housing for the element functions as a sensor to external sound.

Furthermore, dynamic-type microphones have been developed (see FIG. 6). However, the microphone of this type is advantageously less susceptible to vibration but is disadvantageously large. The dynamic type is mainly applied to the throat microphone, which picks up a voice cord vibration, because it has limited sensitivity for structural reasons.

Patent Document 1: Japanese Patent Laid-Open No. 2006-20247

Patent Document 2: Japanese Patent Laid-Open No. 2004-229147

Patent Document 3: Japanese Patent Laid-Open No. 2001-292489

### DETAILED DESCRIPTION

The present invention has been devised in view of the above-described disadvantages of conventional microphones designed to pick up only the voice of a speaker. An advantage of the present invention is to provide a microphone used for telecommunication or speech recognition input in a high noise environment, or more specifically, a vibration pickup microphone that hardly howls even when transmission and reception occur simultaneously.

In order to attain the advantage described above, according to claim 1 of the present invention, a vibration pickup microphone has: a housing attached to a human body contact surface of a transmitter/receiver or the like; a microphone unit of an aerial vibration collecting type incorporated in the housing; and a microphone holder that is made of an elastic material and supports the microphone unit in the housing, the housing has a case having an opening in an upper surface thereof, in which the microphone holder is fitted, and a cover that is made of an elastic material and covers an outer surface of the case, a multilayered diaphragm is disposed on an upper surface of the microphone holder with an air space formed between the multilayered diaphragm and the microphone holder, and a sealed cavity is formed between diaphragms constituting the multilayered diaphragm.

In one embodiment, the multilayered diaphragm has a dome-like shape, the multilayered diaphragm includes two diaphragms, an inner sub diaphragm and an outer sub diaphragm, and the sealed cavity is formed between the inner sub diaphragm and the outer sub diaphragm.

The inner sub diaphragm has a protrusion formed at a center part of an outer surface thereof, and the protrusion abuts against or is fixed to an inner surface of the outer sub diaphragm. Alternatively, the outer sub diaphragm has a protrusion formed at a center part of an inner surface thereof, and the protrusion abuts against or is fixed to an outer surface of the inner sub diaphragm.

The microphone holder has a supporting frame on the upper surface thereof, the supporting frame is fitted into a recess in a bottom surface of the multilayered diaphragm to support the multilayered diaphragm, the multilayered diaphragm has a flange along a lower edge thereof, a circumferential edge of the flange abuts against an inner surface of the case, and the multilayered diaphragm has a spherical outer surface.

As described above, the microphone according to the present invention is less susceptible to external noise and therefore suitable for use as a microphone with a speaker for telecommunication in a high noise environment.

In particular, the microphone unit is sealed in the housing by the inner sub diaphragm, which is separated from the outer sub diaphragm or is in contact with or connected to the outer sub diaphragm only by the protrusion formed at the center thereof. As a result, even when transmission and reception occur simultaneously, insufficient contact between the microphone and the skin causes no howling. Thus, the anti-noise characteristics are advantageously improved, and transmission and reception can occur simultaneously with high quality.

Best modes for carrying out the invention will be described with reference to the accompanying drawings. A vibration pickup microphone according to the present invention has a housing 1 attached to a human body contact surface of a transmitter/receiver or the like, a microphone unit 2 disposed in the housing 1, and a microphone holder 5 disposed in the housing 1 to support the microphone unit 2.

The housing 1 has a case 3 that houses the microphone holder 5 and a cover 4 of the case 3. The microphone holder 5 supporting the microphone unit 2 is fitted into the case 3, and a multilayered diaphragm 6 is disposed to cover the upper surface of the microphone holder 5. The multilayered diaphragm 6 can have a planar shape but most often has a dome-like shape.

The microphone the inventor initially devised had a single-layered diaphragm instead of the multilayered diaphragm 6. However, it was found that, when the microphone is used for transmission and reception simultaneously, the microphone with the single-layered diaphragm disadvantageously howls because the single-layered diaphragm picks up the sound from the speaker if the user wears the microphone after it is turned on, although the microphone does not suffer the problem if the user wears the microphone before it is turned on. To solve this problem, the present invention is improved by replacing the single-layered diaphragm with the multilayered diaphragm 6.

The multilayered diaphragm 6 has a stack of two or more diaphragms made of an elastic material, and a sealed cavity 7 is formed between the diaphragms. The multilayered diaphragm 6 shown in the drawings has a double-layered structure, which has an inner sub diaphragm 6a and an outer sub diaphragm 6b, and the sealed cavity 7 is formed between the inner sub diaphragm 6a and the outer sub diaphragm 6b. For the multilayered diaphragm 6 having a dome-like shape, the sealed cavity 7 is widest at the middle thereof.

The inner sub diaphragm 6a having a dome-like shape has a flange 15 formed along the bottom circumference thereof. The flange 15 rests on the outer edge of the upper surface of the microphone holder 5 in intimate contact therewith. In addition, the circumferential edge of the flange 15 abuts against the inner surface of the case 3 to ensure that the inner sub diaphragm 6a is firmly placed in the case 3, and the outer surface of the inner sub diaphragm 6a is spaced apart from the inner surface of the case 3.

The outer sub diaphragm 6b has a dome-like shape similar to that of the inner sub diaphragm 6a and is disposed to cover the inner sub diaphragm 6a with the sealed cavity 7 formed therebetween as described above. The outer sub diaphragm 6b may be made of the same material as the inner sub diaphragm 6a or other materials slightly softer than the material of the inner sub diaphragm 6a. The inner sub diaphragm 6a and the outer sub diaphragm 6b may be integrally formed or separately formed and then integrated with each other by bonding, welding or the like.

As described later, the inner sub diaphragm 6a firmly placed in the case 3 is fitted onto a supporting frame 14 on the upper surface of the microphone holder 5, and an air space 16 is formed between the inner sub diaphragm 6a and the microphone holder 5. In a typical design, the inner sub diaphragm 6a is as high as or slightly higher than a skin contact part 10 of the upper edge part of the cover 4.

The case 3 is a container having an opening in the upper surface thereof and is typically made of a high specific gravity material, such as brass, stainless steel and iron. The case 3 has an opening 9 formed in a lower part of the side wall thereof, and a lead 8 of the microphone unit 2 is drawn to the outside through the opening 9.

The cover 4 is made of an elastic material with a soft touch, such as silicon rubber, and completely covers the case 3 except for the opening in the upper surface thereof. The upper edge part of the cover 4 is bent to extend inwardly to cover the upper end surface of the case 3, and the inward extension part forms the skin contact part 10, which has an annular shape. The cover 4 also has an opening 11 formed in alignment and communication with the opening 9 of the case 3, and the lead 8 is drawn through the openings 9 and 11.

The microphone holder 5 is also made of an elastic material, such as silicon rubber, and tightly fitted in the case 3. The microphone holder 5 has a circumferential leg 12 in intimate contact with the inner surface of the case 3 and a holding opening 13 for holding the microphone unit 2 at the center of the upper surface thereof. Furthermore, the microphone holder 5 has the supporting frame 14 on the upper surface thereof as described above. The supporting frame 14 has an annular shape and is formed to surround the holding opening 13. The supporting frame 14 is fitted into the spherically recessed bottom surface of the inner sub diaphragm 6a, thereby supporting the multilayered diaphragm 6.

The vibration pickup microphone configured as described above is used by pressing the outer sub diaphragm 6b against a skin 20 of a cheek or other body part as shown in FIG. 2. Since the outer sub diaphragm 6b is made of a material as soft as or softer than the material of the inner sub diaphragm 6a, the outer sub diaphragm 6b inwardly collapses and comes into surface contact with the inner sub diaphragm 6a so that the two sub diaphragms behave like a one-piece diaphragm when it is pressed against the skin (the air in the sealed cavity 7 moves to the peripheral part while widening the clearance between the sub diaphragms 6a and 6b).

Since the inner sub diaphragm 6a is as high as or higher than the skin contact part 10 of the cover 4, the outer surface of the outer sub diaphragm 6b in contact with the inner sub diaphragm 6a is higher than the skin contact part 10 of the cover 4 and therefore adequately and reliably comes into intimate contact with the skin 20.

When the outer sub diaphragm 6b is pressed against the skin 20, the skin contact part 10 of the cover 4 also comes into intimate contact with the skin 20. Even in this case, the skin contact part 10 does not inhibit the contact between the inner sub diaphragm 6a and the outer sub diaphragm 6b, because the inner sub diaphragm 6a is as high as or higher than the skin contact part 10. The elasticity of the skin also helps the outer sub diaphragm 6b collapsed and in contact with the inner sub diaphragm 6a to adequately and reliably come into intimate contact with the skin 20.

Thus, when the wearer vocalizes, the outer sub diaphragm 6b picks up the bone vibration or vocal cord vibration and vibrates with the inner sub diaphragm 6a like a one-piece diaphragm.

The vibration of the outer sub diaphragm 6b and the inner sub diaphragm 6a makes the air in the air space 16 vibrate to produce a sound wave, which reaches a diaphragm of the microphone unit 2. In this process, the air space 16 is completely isolated from the outside, and therefore, no external noise reaches the microphone unit 2.

In addition, the microphone unit 2 is essentially configured to hardly pick up a mechanical vibration. Therefore, the vibration pickup microphone according to the present invention is extremely tolerant to vibration and external noise.

Furthermore, the housing 1 has the case 3 and the cover 4, and the case 3 is made of a high specific gravity material, such as brass, stainless steel and iron, to reduce the sensitivity to sound pressure. On the other hand, the cover 4 is made of an elastic material, so that the cover 4 ensures the hermeticity of the inside when the microphone is pressed against the skin 20 until the skin contact part 10 comes into contact with the skin 20. Thus, the cover 4 also effectively prevents introduction of external noise. Furthermore, the microphone holder 5 is made of an elastic material, so that the microphone holder 5 is less sensitive to unwanted vibrations.

When the microphone is separated from the skin 20 after use, the outer sub diaphragm 6b is detached from the inner sub diaphragm 6a by the action of the elasticity thereof, and the sealed cavity 7 between the sub diaphragms 6a and 6b is restored to the original state. Compared with a vibration pickup microphone that has no outer sub diaphragm 6b, the sensitivity to external noise of this microphone is improved by approximately 10 dB (see FIG. 3).

FIG. 4 shows another embodiment of the present invention, which is the same as the above-described embodiment except that a small protrusion 18 is formed on the outer surface of the inner sub diaphragm 6a. The upper end of the protrusion 18 always abuts against or is fixed to the inner surface of the outer sub diaphragm 6b. The protrusion 18 may be formed on the outer sub diaphragm 6b.

In any of the possible cases described above, the outer sub diaphragm 6b and the inner sub diaphragm 6a are connected to each other only by the protrusion 18, so that this embodiment has the same effects and advantages as the embodiment described above.

The present invention has been described in some detail with regard to most preferred embodiments thereof. However, it is obvious that various different embodiments can be devised without departing from the spirit and scope of the present invention. Therefore, the present invention is not limited to those specific embodiments but limited only by the accompanying claims.

### BRIEF DESCRIPTION OF THE DRAWINGS

FIG. 1 is a vertical cross-sectional view showing a configuration of a vibration pickup microphone according to an embodiment of the present invention;

FIG. 2 is a diagram showing the vibration pickup microphone according to the present invention in operation;

FIG. 3 is a graph showing measurements of the sensitivity to external noise of the vibration pickup microphone according to the present invention and a conventional vibration pickup microphone;

FIG. 4 is a vertical cross-sectional view showing a configuration of a vibration pickup microphone according to another embodiment of the present invention;

FIG. 5 is a vertical cross-sectional view showing an exemplary configuration of a conventional bone conduction microphone; and

FIG. 6 is a vertical cross-sectional view of a conventional dynamic-type microphone.

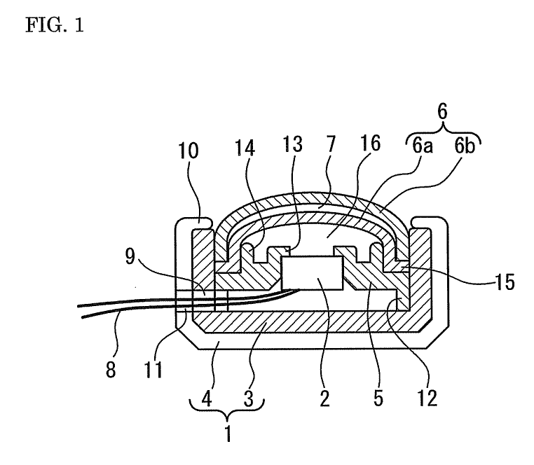

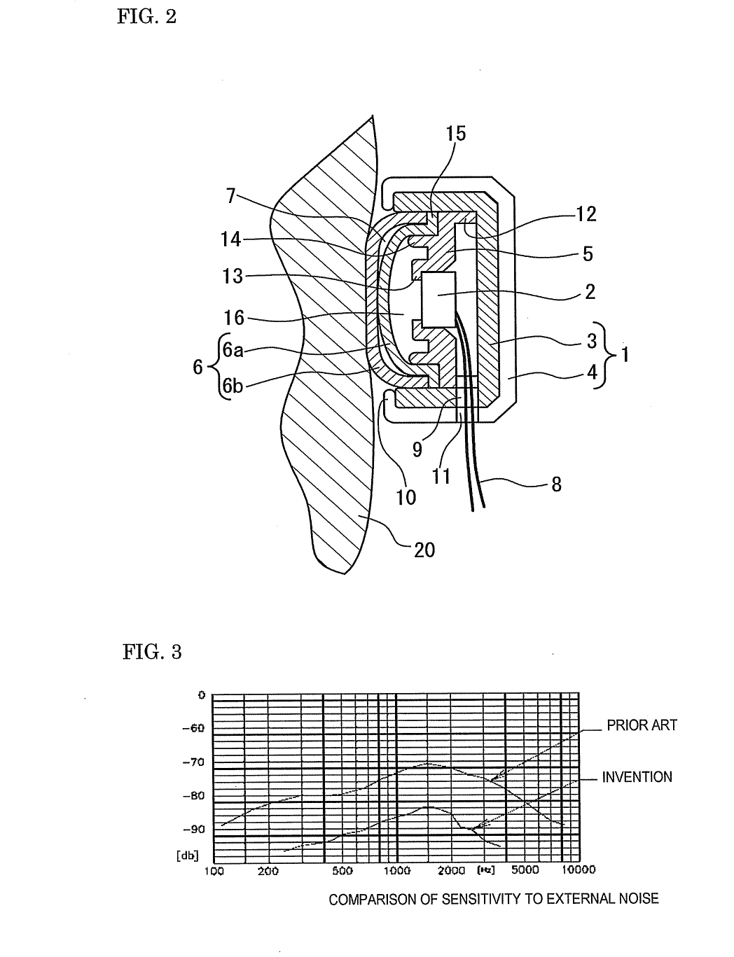

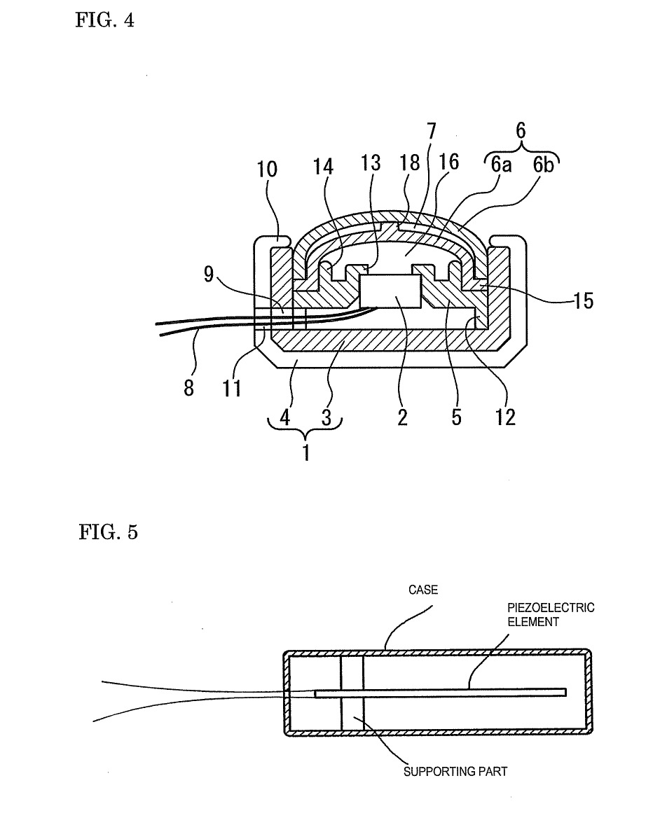

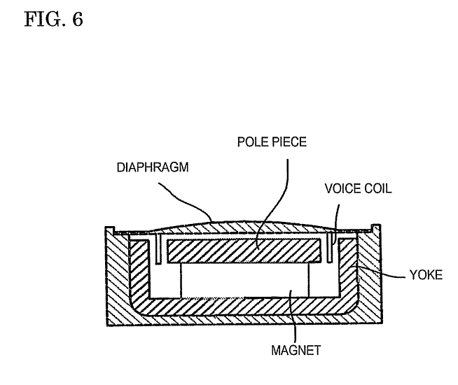

1. A vibration pickup microphone, comprising:
a housing adapted to be attached to a human body contact surface of a transmitter/receiver;
a microphone unit of an aerial vibration collecting type incorporated in said housing; and
a microphone holder that is made of an elastic material and supports said microphone unit in said housing,
wherein said housing has a case having an opening in an upper surface thereof, in which said microphone holder is fitted, and a cover that is made of an elastic material and covers an outer surface of said case, a multilayered diaphragm is disposed on an upper surface of said microphone holder with an air space formed between said multilayered diaphragm and said microphone holder, and a sealed cavity is formed between diaphragms constituting said multilayered diaphragm.

2. The vibration pickup microphone according to claim 1, wherein said multilayered diaphragm has a dome-like shape.

3. The vibration pickup microphone according to claim 1, wherein said multilayered diaphragm includes two diaphragms, an inner sub diaphragm and an outer sub diaphragm, and said sealed cavity is formed between said inner sub diaphragm and said outer sub diaphragm.

4. The vibration pickup microphone according to claim 3, wherein said inner sub diaphragm has a protrusion formed at a center part of an outer surface thereof, and the protrusion abuts against or is fixed to an inner surface of said outer sub diaphragm.

5. The vibration pickup microphone according to claim 3, wherein said outer sub diaphragm has a protrusion formed at a center part of an inner surface thereof, and the protrusion abuts against or is fixed to an outer surface of said inner sub diaphragm.

6. The vibration pickup microphone according to claim 1, wherein said microphone holder has a supporting frame on the upper surface thereof, and the supporting frame is fitted into a recess in a bottom surface of said multilayered diaphragm to support said multilayered diaphragm.

7. The vibration pickup microphone according to claim 1, wherein said multilayered diaphragm has a flange along a lower edge thereof, and a circumferential edge of the flange abuts against an inner surface of said case.

8. The vibration pickup microphone according to claim 1, wherein said multilayered diaphragm has a spherical outer surface.
